(19) United States
(12) Patent Application Publication
(10) Pub. No.: US 2005/0196134 A1
(43) Pub. Date: Sep. 8, 2005

(54) Electromagnetic signal receiving device

(75) Inventor: Cheng-Fu Lee, Taipei City (JP)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/052,028

(22) Filed: Feb. 8, 2005

(30) Foreign Application Priority Data
Mar. 3, 2004 (TW) 93203172

(51) Int. Cl. G01S 5/02

(52) U.S. Cl. 386/46

(57) ABSTRACT

The present invention discloses an electromagnetic signal receiving device which includes a signal receiver and a reflective means. The reflective means is disposed in to the vicinity of the signal receiver for guiding a first electromagnetic signal from a first direction and a second electromagnetic signal from a second direction to a signal reception area of the signal receiver.

This application claims the benefit of Taiwan Patent Application Serial No. 93203172, filed Feb. 3, 2004, the subject matter of which is incorporated herein by reference.

### BACKGROUND OF THE INVENTION

1. Field of the Invention

The invention relates in general to an electromagnetic signal receiving device, and more particularly to an electromagnetic signal receiving device with several reflective planes for receiving the signals from different directions.

2. Description of the Related Art

In the recent years, due to the blooming development of the digital products, the digital versatile disc player has played an important role among the family appliances. Due to the limited space, the appliances tends to be so miniaturized that can be placed in variety of ways, such as stand-up, upside-down, lateral side-down, and wall-hanging. In order to have both free arrangement and remote-controlling of the appliances, the appliances should be designed for receiving the electromagnetic signals in all directions. Therefore, whatever the positions the appliances are placed, they always can be remote-controlled by users.

FIG. 1 schematically shows a conventional electronic device capable of receiving electromagnetic signals. The conventional electronic device 10 includes a body 11, and two signal receivers 20 and 30. The signal receiver 20 is disposed at the edge of the body 11 for receiving the electromagnetic signal 41 which emits from the direction as indicated by arrow a. The signal receiver 30 for receiving the electromagnetic signal emitting from the direction as indicated by the arrow b is disposed perpendicularly to the signal receiver 20. Thus, the electronic device 10 with two signal receivers 20 and 30 could receive the electromagnetic signals from two different directions. In spite of the posture of the electronic device 10 is changed, such as stand-up or lateral side-down, one of those signal receivers could receive the electromagnetic signal emitted from the remote controller.

However, the conventional electronic device needs to be equipped with two or more signal receivers in order to receive the electromagnetic signals from all directions. It raises the cost of manufacture and deteriorates the competitiveness of the electronic device by its high price.

### SUMMARY OF THE INVENTION

It is therefore an object of the invention to provide an electromagnetic signal receiving device which can receive electromagnetic signal in all directions only by one signal receiver.

The invention achieves the above-identified object by providing an electromagnetic signal receiving device which includes a signal receiver and a reflective means for guiding a first electromagnetic signal from a first direction and a second electromagnetic signal from a second direction to a signal reception area of the signal receiver.

Moreover, the invention achieves the above-identified object by providing an electromagnetic signal guiding device disposed in the vicinity of a signal receiver. The electromagnetic signal guiding device includes a transparent object, a first reflective plane, and a second reflective plane. The transparent object has a first and second part, both of which intersect at a predetermined angle. The reflective means is used for guiding a first electromagnetic signal from a first direction and a second electromagnetic signal from a second direction to a reception area of the signal receiver.

Further, the invention achieves the above-identified object by providing an electronic device capable of receiving electromagnetic signals. The electronic device includes a signal receiver and a transparent object, and a reflective means. The transparent object has a first part and a second part, both of which intersect at a predetermined angle. The reflective means is used for guiding a first electromagnetic signal from a first direction and a second electromagnetic signal form a second direction to a reception area of the signal receiver.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 schematically shows a conventional electronic device capable of receiving electromagnetic signal.

FIG. 2 schematically illustrates a perspective view of an electronic device having an electromagnetic signal receiving device according to the first embodiment of the invention.

FIG. 3A schematically shows an enlarging view illustrating the electromagnetic signal receiving device of FIG. 2.

FIG. 3B schematically illustrates a cross-sectional view of the electromagnetic signal receiving device taken along the Y-Z plane of FIG. 3A.

FIG. 4 schematically illustrates a perspective view of an electronic device having an electromagnetic signal receiving device according to the second embodiment of the invention.

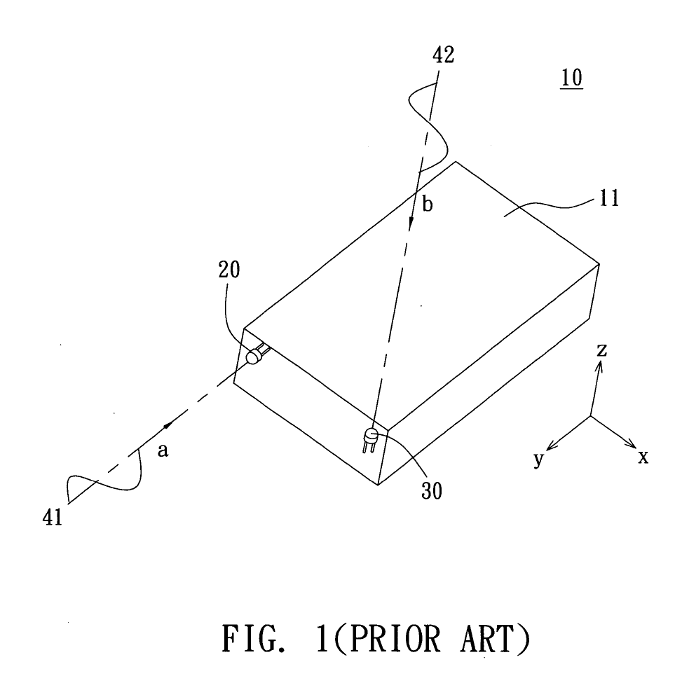

### DETAILED DESCRIPTION OF THE INVENTION

### The First Embodiment

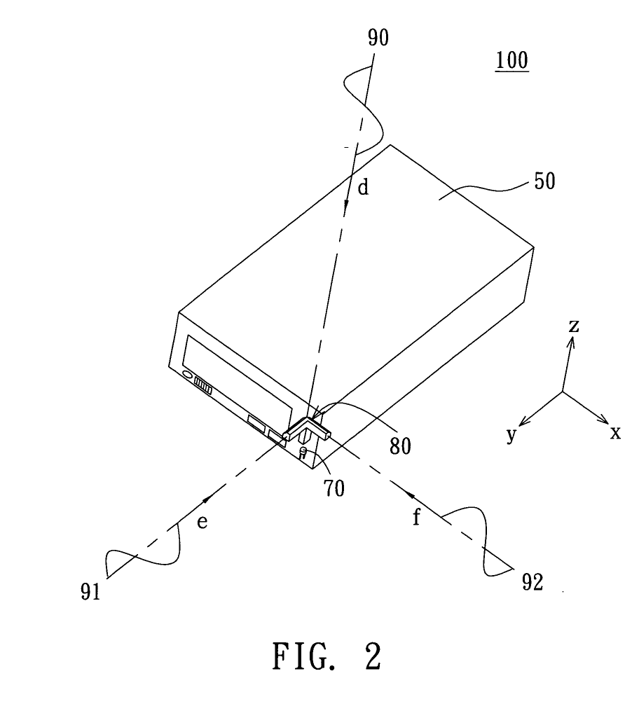

Referring to FIG. 2, it is a perspective view illustrating an electronic device having an electromagnetic signal receiving device according to the first embodiment of the invention. The electronic device 100 includes a body 50 and an electromagnetic signal receiving device 60. The electromagnetic signal receiving device 60 includes a signal receiver 70 and an electromagnetic signal guiding device 80. The signal receiver 70, disposed in the interior of the body 50, includes a reception area used for receiving the electromagnetic signal (EM signal) from a predetermined receiving direction, such as the electromagnetic signal 90 from direction d. The electromagnetic signal guiding device 80, disposed in the vicinity of the signal receiver 70, is used for guiding electromagnetic signals to the signal receiver 70 from several of directions other to the signal receiver 70 can receive. For example, the electromagnetic signal 91 from the first direction e and the electromagnetic wave signal 92 from the second direction f can be guided by the electromagnetic signal guiding device 80, and then received by the signal receiver 70.

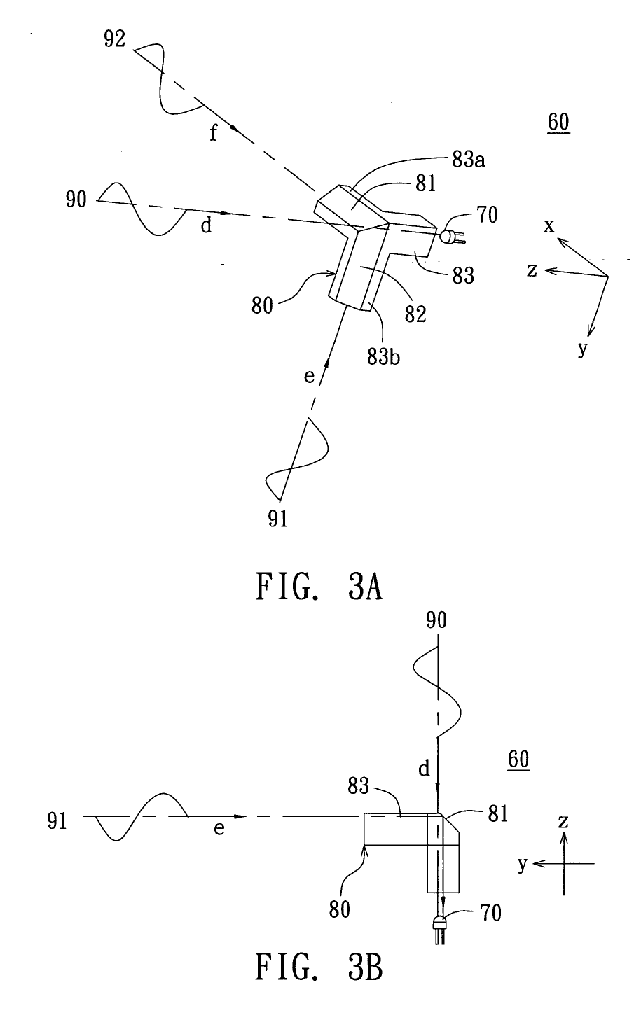

Referring to FIG. 3A, it shows an enlarging view illustrating the electromagnetic signal receiving device of FIG. 2. The electromagnetic signal guiding device 80 includes a transparent object 83, a first reflective plane 81 disposed at a first part 83a, and a second reflective plane 82 disposed at a second part 83b. The first part 83a and the second part 83b intersect at a predetermined angle, preferably about 90 degrees. The first reflective plane 81 is disposed at the first part 83a with a first reflecting angle for guiding the signals out of the reception area of the signal receiver 70 such as the first electromagnetic signal 91 from the first direction e to the reception area of the signal receiver 70. For example, the first electromagnetic signal 91 from the first direction e could be guided by the first reflective plane 81, and then be received by the signal receiver 70. The second reflective plane 82 is disposed on the second part 83b of the transparent object 83. The second reflective plane 82 is arranged relatively to the signal receiver 70 at a second reflecting angle for guiding the electromagnetic signal from the direction different to what the first reflective plane 81 can guide to the reception area of the signal receiver 70. Such as the second electromagnetic signal 92 from the second direction f, could be guided by the second reflective plane 82, and then received by the signal receiver 70 as shown in FIG. 3A.

The transparent object 83 of the electromagnetic signal guiding device 80 is preferably a prism. Moreover, the first part 83a and the second part 83b of the transparent object 83 are intersected at a suitable angle, and preferably 90 degrees. The first reflecting angle and the second reflecting angle as mentioned above are preferably both 45 degrees.

Referring to the FIG. 3B, it shows a cross-sectional view of the electromagnetic signal receiving device taken along the Y-Z plane of FIG. 3A. In the electromagnetic signal guiding device, the first reflective plane 81 is arranged relatively to the signal receiver 70 at the first reflecting angle, and preferably 45 degrees. According to the reflection theory of the plane mirror, the first electromagnetic signal 91 from the first direction e can be reflected to the signal receiver 70 via the first reflective plane 81. It allows the signal receiver 70 to receive both the electromagnetic signal 90 from the predetermined receiving direction d and the electromagnetic signal 91 from the first direction e which is originally out of the reception area of the signal receiver 70.

In addition, the second reflective plane 82 is also arranged relatively to the signal receiver 70 at the second reflecting angle which is preferably 45 degrees. According to the reflection theory on plane mirror, the electromagnetic signal 92 from the second direction f can be reflected to the signal receiver 70 by the second reflective plane 82. It further allows the signal receiver 70 to receive the electromagnetic signal 90 from the predetermined receiving direction d, the electromagnetic signal 91 from the first direction e, and the electromagnetic signal 92 from the second direction f.

Besides, the first and second reflective plane 81, 82 can be coated metal layers to enhance the reflectivity.

Furthermore, the electromagnetic signal receiving device could be applied to different kinds of electronic devices, such as the digital versatile disc (DVD) player, the digital versatile disc (DVD) recorder, the optical disc drive, the set-top box, the information appliances and other device equipped with function for receiving electromagnetic signals.

### The Second Embodiment

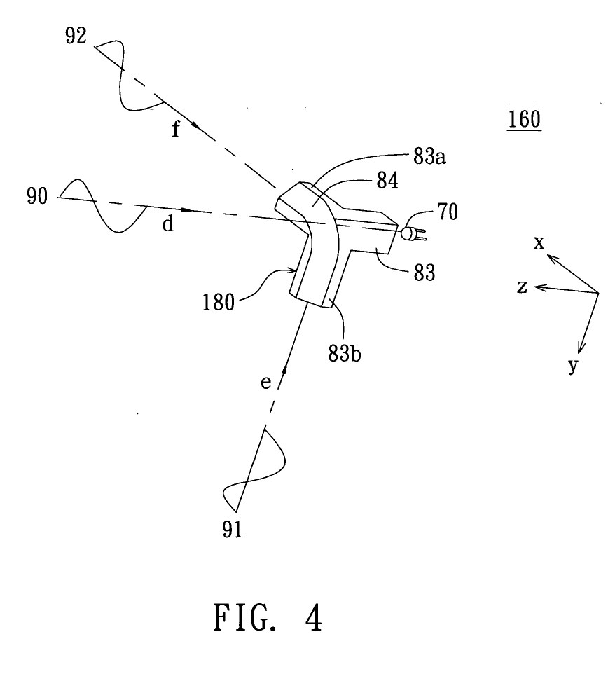

Referring to the FIG. 4, it shows a perspective view of the electromagnetic signal receiving device according to the second embodiment of the invention. The difference between the first and the second embodiment is the reflective means used in the electromagnetic signal guiding device. A curved reflective surface is utilized in the second embodiment to replace the first and the second reflective plane in the first embodiment. Besides, similar elements in the second embodiment as described in FIG. 4 share the same numbering as shown in FIG. 3A.

In the electromagnetic signal receiving device 160 as shown in FIG. 4, one portion of the curved reflective surface 84 is disposed on the first part 83a of the transparent object 83, and the other portion of the curved reflective surface 84 is disposed on the second part 83b of the transparent object 83. The curved reflective surface 84 is used for guiding the first electromagnetic signal 91 from the first direction e and the second electromagnetic signal 92 from the second direction f to the reception area of the signal receiver 70. Thus it allows the signal receiver 70 to receive the electromagnetic signals coming from various directions. Accordingly, the electromagnetic signal 90 from the direction d, the electromagnetic signal 91 from the first direction e, and the electromagnetic signal 92 from the second f, for example, can all be received by a single signal receiver 70.

The electromagnetic signal receiving device disclosed in those embodiments stated above can receive electromagnetic signals from various directions. The electronic device having the electromagnetic signal receiving device of the invention can be remotely controlled in any direction, so that it can be placed in any way and still work. It offers the freedom of arrangement within a limited space. Besides, the electronic device according to the invention is capable of receiving electromagnetic signals from various directions only by one signal receiver. Therefore the number of the signal receivers used in the product can be minimized (i.e. one signal receiver), so that the cost of manufacture can be greatly reduced.

While the invention has been described by way of examples and in terms of the preferred embodiments, it is to be understood that the invention is not limited thereto. For example, the two reflective planes are utilized for guiding electromagnetic signals from two different directions in the embodiment, but people who skilled in the art realize that several reflectors could be used for guiding electromagnetic signals from several directions. It is intended to cover various modifications and similar arrangements and procedures, and the scope of the appended claims therefore should be accorded the broadest interpretation so as to encompass all such modifications and similar arrangements and procedures.

1. An electromagnetic signal receiving device, disposed in an electronic device, the electromagnetic signal receiving device comprising:
a signal receiver; and
a reflective means for guiding a first electromagnetic signal from a first direction and a second electromagnetic signal from a second direction to a reception area of the signal receiver.

2. The electromagnetic signal receiving device according to claim 1 further comprises a transparent object disposed in the vicinity of the signal receiver for supporting the reflective means, and the transparent object has a first part and a second part intersecting at a predetermined angle.

3. The electromagnetic signal receiving device according to claim 1, wherein the reflective means comprises:
a first reflective plane, disposed in relation to the signal receiver with a first reflecting angle for guiding the first electromagnetic signal from the first direction to the reception area of the signal receiver; and
a second reflective plane, disposed in relation to the signal receiver with a second reflecting angle for guiding the second electromagnetic signal from the second direction to the reception area of the signal receiver.

4. The electromagnetic signal receiving device according to claim 3, wherein the first reflecting angle and the second reflecting angle are both 45 degrees.

5. The electromagnetic signal receiving device according to claim 1, wherein the reflective means comprises:
a curved reflective surface, arranged relatively to the signal receiver for guiding the first and the second electromagnetic signals to the reception area of the signal receiver.

6. The electromagnetic signal receiving device according to claim 2, wherein the first and the second parts of the transparent object intersect at 90 degrees.

7. The electromagnetic signal receiving device according to claim 2, wherein the transparent object is a prism.

8. The electromagnetic signal receiving device according to claim 1, wherein the reflective means is coated with a metal film.

9. The electromagnetic signal receiving device according to claim 1, wherein the electronic device is a digital versatile disc (DVD) player, a digital versatile disc (DVD) recorder, an optical disc drive, a set-top box, or an information appliance (IA).

10. An electromagnetic signal guiding device, disposed in the vicinity of a signal receiver, the electromagnetic signal guiding device comprising:
a transparent object having a first part and a second part, the first part and the second part intersecting at an predetermined angle;
a reflective means for guiding a first electromagnetic signal from a first direction and a second electromagnetic signal from a second direction to a reception area of the signal receiver.

11. The electromagnetic signal guiding device according to the claim 10, wherein the reflective means comprises:
a first reflective plane, disposed in relation to the signal receiver at a first reflecting angle for guiding the first electromagnetic signal from the first direction to the reception area of the signal receiver; and
a second reflective plane, disposed in relation to the signal receiver at a second reflecting angle for guiding the second electromagnetic signal from the second direction to the reception area of the signal receiver.

12. The electromagnetic signal guiding device according to the claim 11, wherein the first reflecting angle and the second reflecting angle are both 45 degrees.

13. The electromagnetic signal guiding device according to the claim 10, wherein the reflective means comprises,
a curved reflective surface, arranged relatively to the signal receiver for guiding the first and the second electromagnetic signals to the reception area of the signal receiver.

14. The electromagnetic signal guiding device according to the claim 10, wherein the first and the second parts of the transparent object intersect at 90 degrees.

15. The electromagnetic signal guiding device according to the claim 10, wherein the transparent object is a prism.

16. The electromagnetic signal guiding device according to the claim 10, wherein the reflective means is coated with a metal film.

17. An electronic device capable of receiving electromagnetic signals comprises:
a signal receiver; and
a transparent object having a first part and a second part, the first part and the second part intersecting at an predetermined angle;
a reflective means for guiding a first electromagnetic signal from a first direction and a second electromagnetic signal from a second direction to a reception area of the signal receiver.

18. The electronic device according to claim 17, wherein the reflective means comprises:
a first reflective plane, disposed in relation to the signal receiver with a first reflecting angle for guiding the first electromagnetic signal from the first direction to the reception area of the signal receiver; and
a second reflective plane, disposed in relation to the signal receiver with a second reflecting angle for guiding the second electromagnetic signal from the second direction to the reception area of the signal receiver.

19. The electronic device according to claim 17, wherein the reflective means comprises:
a curved reflective surface, arranged relatively to the signal receiver for guiding the first and the second electromagnetic signals to the reception area of the signal receiver.

20. The electronic device according to the claim 17 is a digital versatile disc (DVD) player, a digital versatile disc (DVD) recorder, an optical disc drive, a set-top box, or an information appliance (IA).
